(19) United States
(12) Patent Application Publication
(10) Pub. No.: US 2008/0089056 A1
(43) Pub. Date: Apr. 17, 2008

(54) Illuminated Apparel

(76) Inventor: Ronald Grosjean, Pleasanton, CA (US)

Correspondence Address: WEST & ASSOCIATES, A PC, 2815 MITCHELL DRIVE, SUITE 209, WALNUT CREEK, CA, 94598, US

(21) Appl. No.: 11/868,958

(22) Filed: Oct. 8, 2007

Related U.S. Application Data
(60) Provisional application No. 60/828,592, filed on Oct. 6, 2006.

(51) Int. Cl. F21V 21/08

(52) U.S. Cl. 362/103

(57) ABSTRACT

Illuminated garments and accessories for enhancing a person's visual appearance for aesthetic and safety reasons. The lighting on the garments and accessories can be activated by attached or remote manual controls or sensors. Embodiments can include apparel for motorcyclists, bicyclists, road workers, or for general entertainment purposes.

### STATEMENT OF PRIORITY

The following application claims priority to U.S. Provisional Patent Application No. 60/828,592, filed Oct. 6, 2006, the complete contents of which are hereby incorporated by reference.

### BACKGROUND

1. Field of the Invention

The present disclosure relates to the field of clothing and accessories, including those worn as safety devices and fashion accessories.

2. Background

A person's appearance can be an important factor in several professional, leisure, and general activities. In particular, visibility can play a critical role in safety, or simply be the desired result of wearing a certain color or pattern. Therefore, some garments and accessories can be worn to enhance visibility for safety and aesthetic purposes.

For example, although motorcycles are a common sight on the road, many motorists have difficulty seeing them because they are smaller than other vehicles. Accidents occur every day between motorcycles and cars, after which the automobile drivers say, “I just didn't see him until it was too late.” This is especially true at night, when motorcyclists are even more difficult to see since they often wear black leather protective gear.

Motorcyclists can try to mitigate their risk on the road by wearing many forms of protective gear, some of which enhances their visibility through the use of bright colors or reflective materials. Many jackets and helmets feature brightly colored patterns or reflective patches. However, sometimes this is not enough to increase visibility to other motorists.

Accidents in which a car rear-ends a motorcycle are common due to several factors. Automobile drivers who do not realize that a motorcycle can have an increased stopping distance follow too closely, and if the motorcyclist must suddenly stop, the car hits the motorcycle from behind. In addition, automobile drivers may not immediately see a motorcycle's tail-light because it is usually below their eye level, as well as small. If the automobile driver even sees the flash or brightening of the tail-light, it may be too late to stop before hitting the motorcycle.

Several devices have been developed to increase the visibility of motorcyclists when braking, but these have seen limited use. One such device, the “RiderLight,” is a small strip of LEDs and a receiver that is affixed to the back of a motorcycle helmet. A “transmitter bulb” replaces the conventional brakelight bulb. When a motorcyclist hits the brakes, the transmitter bulb sends a signal to the LED strip, causing it to light up.

This device can help to improve visibility, particularly at night, but it has some shortcomings. First, the rear surface of a motorcycle helmet, especially a half-helmet, such as the type worn by police officers, does not provide much surface area to accommodate a light. LEDs are bright, but relatively small, and only six collinear lights are on the strip itself. Although placing the lights on the helmet puts them more at the eye level of an automobile driver, visibility of the lights can be significantly decreased if a rider turns his head to the side, as motorcyclists often do.

In addition to the visibility issues, some motorcyclists do not like the idea of affixing any kind of adhesive to their helmets. Although primarily a functional piece of safety equipment, helmets have aesthetic qualities, such as the exterior finish, that adhesives can permanently damage. Further, if the lights need replacing, removing the adhesive strip could be difficult and inconvenient.

Motorcyclists also face the danger of being hit by a car if they are thrown off of their motorcycles during an accident. A motorcyclist may not be severely injured in the initial collision, but is subsequently even more vulnerable while sliding along the ground, probably on the road. This is even worse at night, when a motorcyclist, probably wearing black, would be almost invisible to a driver of a car. Further, emergency personnel can have difficulty locating an injured motorcyclist if a she is thrown a significant distance from the motorcycle, or lands off the road in thick brush, or falls down a steep cliff.

Although bicyclists usually do not face as much chance of being rear-ended as motorcyclists, visibility to motorists is a critical safety issue. Bicyclists may need to brake suddenly to change direction, which can make them vulnerable to being hit by a car. Although brightly colored and reflective vests are presently available, these do not provide any added visibility when a bicyclist applies the brakes.

Road workers often work in close proximity to moving traffic. Unfortunately, they can blend into the vehicles and equipment that are either on or at the side of the road, and car drivers do not see them. These workers use brightly colored, reflective vests and helmets to make themselves more visible and increase safety on the job. However, the bright colors are only visible during daylight hours, and the reflective materials are only effective when another source of light is present. Further, drivers often cannot see road workers until they are very close to them.

In addition to safety applications, self-contained illuminated garments can be used for aesthetic and entertainment purposes. People often select garments for their color or style, which can indicate an affiliation with a particular group or make an individual stand out and be noticed. For example, just as creatures in the wild display particular or even vibrant markings to attract attention, people often wear clothing or other accessories to do the same. As another example, sports fans could support their teams during night events while illuminated in team colors.

Night-club patrons could draw attention to themselves on a dance floor by wearing garments with steady or pulsating lights. Further, the lights on the garments could be controlled by the individuals wearing them, responsive to the music, or controlled by another person, such as a disc jockey or other emcee.

Just as a giant squid puts on a luminescent display to attract a mate, a person wearing an illuminated garment could send a message via the color or pattern of the lights to attract interest from others. In some populations, wearing a particular color or pattern of handkerchief in a certain position can indicate sexual interest or preferences. For example, wearing an orange handkerchief on the right can mean that a person isn't interested in meeting anyone, but is “just looking.” Wearing it on the left can indicate that a person is interested in “anything anytime.” A person could do likewise with a personal display of lights.

Lighting can also play an integral part in theatrical productions. Stage lights can achieve various effects to indicate times of day or otherwise set the mood for a scene. Actors wearing illuminated garments could further communicate information, emotions, and themes, or simply achieve attractive visual effects, with colors and patterns of light. Participants in night-time performances, such as at halftime shows or Olympic Games opening ceremonies could achieve spectacular visual effects with illuminated garments controlled by themselves or a remote central control, the audience, or music.

What is needed is apparel and accessories that provide their own source of light and can receive activation signals from connected or remote input sources.

### BRIEF DESCRIPTION OF THE DRAWINGS

FIG. 1 shows a diagram of one embodiment of the present device.

FIG. 1a shows a schematic diagram of one embodiment of a lighting source having an array of lighting elements.

FIG. 1b depicts an alternate embodiment of the device depicted in FIG. 1.

FIG. 1c depicts an alternate embodiment of the device depicted in FIG. 1.

FIG. 1d depicts an alternate embodiment of the device depicted in FIG. 1.

FIG. 1e depicts an alternate embodiment of the device depicted in FIG. 1.

FIG. 2 shows a diagram of another embodiment of the present device having a remote transmitter and receiver.

FIG. 3 shows a diagram of another embodiment of the present device in use on a motorcycle.

FIG. 3a shows a schematic diagram of one embodiment of a circuit of the present device for use with riding a motorcycle having a wired connection between the components on the motorcycle and those on a garment.

FIG. 3b shows a schematic diagram of one embodiment of a circuit of the present device for use with riding a motorcycle having a wireless connection between the components on the motorcycle and those on a garment.

FIG. 3c shows a sub-schematic diagram of one embodiment of an input device.

FIG. 3d shows a sub-schematic diagram of one embodiment of an input device having an additional microcontroller.

FIG. 3e shows a sub-schematic diagram of one embodiment of a wireless transmitter in the present device.

FIG. 3f shows a sub-schematic diagram of one embodiment of a wireless receiver in the present device.

FIG. 4 shows a diagram of another embodiment of the present device in use as a safety device for road workers.

FIG. 4a shows a schematic diagram of one embodiment of a circuit of the present device for use in applications as a safety device for road or other types of workers having a wired connection between the remote components and those on a garment.

FIG. 4b shows a schematic diagram of one embodiment of a circuit of the present device for use in applications as a safety device for road or other types of workers having a wireless connection between the remote components and those on a garment.

FIG. 4c shows a sub-schematic diagram of one embodiment of an input device.

FIG. 4d shows a sub-schematic diagram of one embodiment of an input device having an additional microcontroller.

FIG. 4e shows a sub-schematic diagram of one embodiment of a wireless transmitter in the present device.

FIG. 4f shows a sub-schematic diagram of one embodiment of a wireless receiver in the present device.

FIGS. 5 and 5.1 shows a diagram of another embodiment of the present device in use as a visually enhancing aesthetic garment.

FIG. 5a shows a sub-schematic diagram of one embodiment of a wireless transmitter in the present device.

FIG. 6 depicts an alternate embodiment of the device in use as a safety device.

FIG. 7 depicts an alternate embodiment of the device implemented in a backpack.

### DETAILED DESCRIPTION

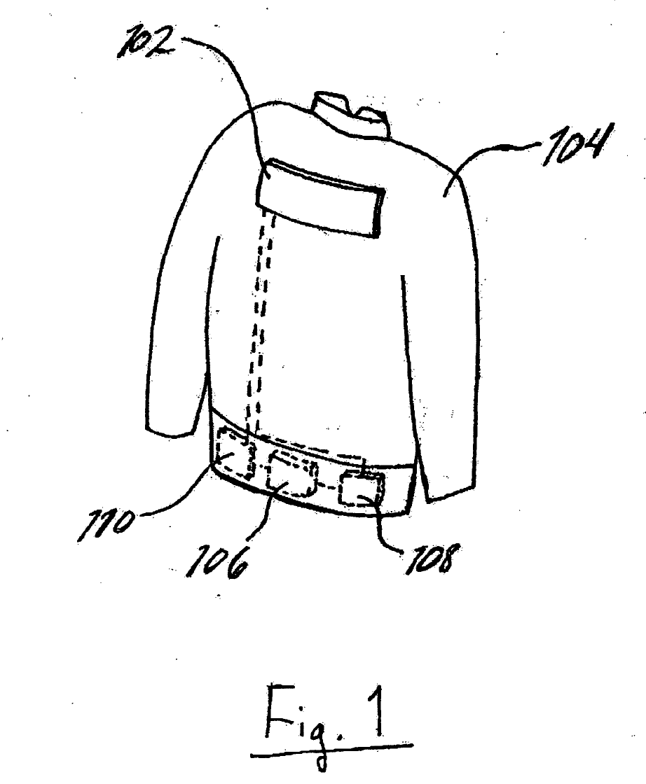

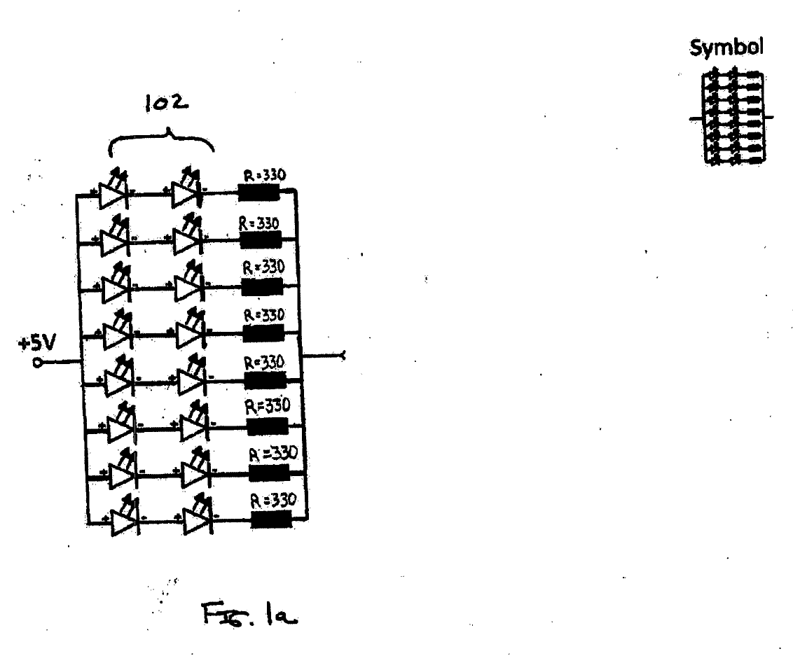

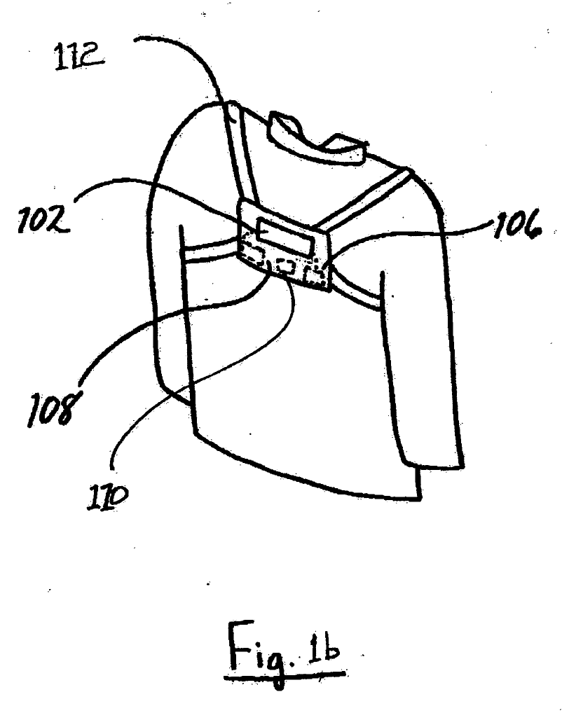

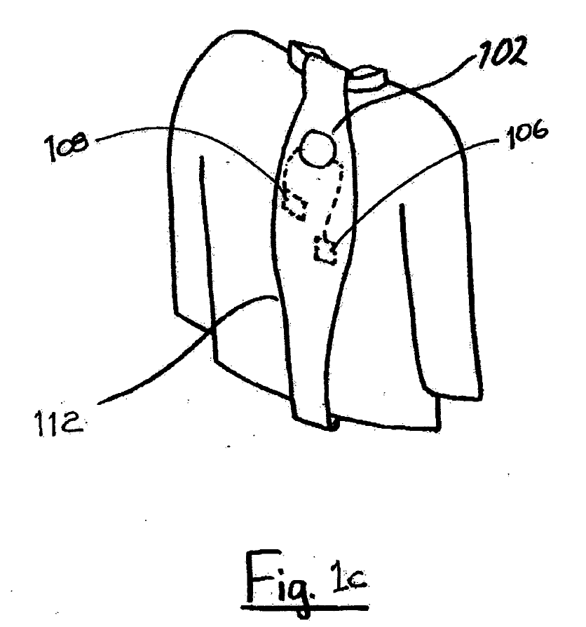

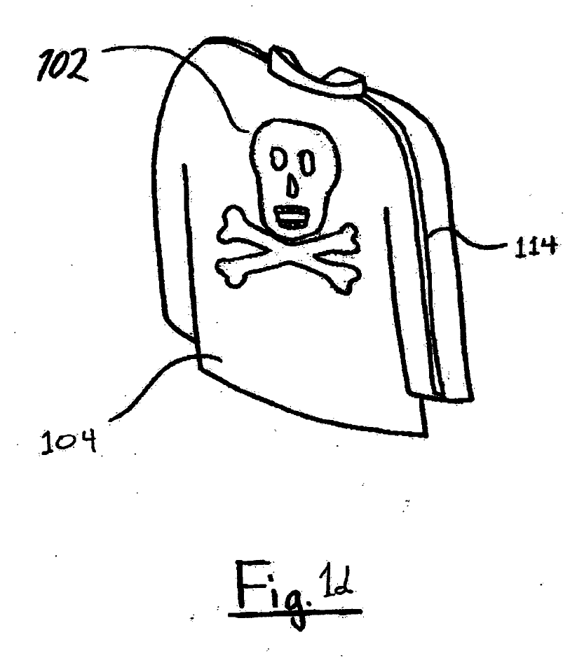

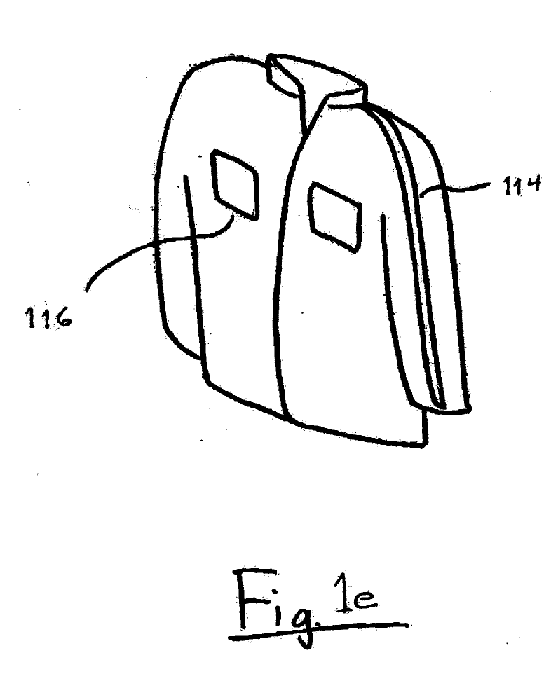

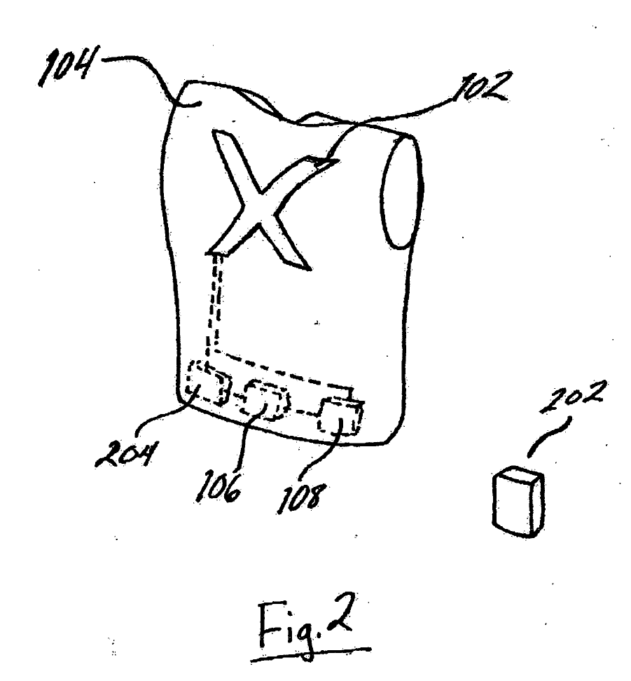

FIG. 1 shows a diagram of one embodiment of the present device. In this embodiment, a lighting source 102 can be affixed to or integrated with a garment 104. A lighting source 102 can be connected in a circuit to a switch 106 and a power source 108, and an input device 110.

In some embodiments, a lighting source 102 can be a light-emitting diode (LED), incandescent bulb, fluorescent bulb, carbide lamp, neon tube, or any known and/or convenient source of light. A lighting source 102 can be a singular element or a plurality of elements, comprising either the same or combinations of different types of lighting sources, arranged in any known and/or convenient geometry or pattern. In some embodiments, a lighting source 102 can be arranged in a configuration to produce a textual display, symbol, picture, aesthetically pleasing design, random pattern, or any other known and/or convenient display.

In some embodiments, a lighting source 102 can emit a red color similar to that emitted by a vehicular brake light. In other embodiments, a lighting source 102 but can emit other vehicular-lighting colors, such as yellow, amber, white, or any other known and/or convenient colors. In some embodiments, a lighting source 102 can emit wavelengths corresponding to any known and/or convenient color in the visible electromagnetic spectrum. Alternatively, a lighting source can emit wavelengths of light outside of the visible electromagnetic spectrum, such as infrared or ultraviolet light, or any other known and/or convenient wavelength.

In embodiments wherein a lighting source 102 has a plurality of elements, each of these elements can emit the same color and brilliance to produce a uniform display. Alternatively, these elements can emit a variety of colors and levels of brilliance to produce a varied display. Such a varied display can be random or arranged to produce a desired visual effect.

A lighting source 102 can be activated to emit a steady beam of light, blink in an intermittent random or regular pattern, gradually or quickly dim or brighten, or any other known and/or convenient mode. The intensity, frequency, brilliance, or emitting pattern of a lighting source 102 can be controlled or varied by the user or a remote source by a switch, input device, or any other known and/or convenient device.

In some embodiments, as shown in FIG. 1, where a garment 104 can be an upper-body garment, such as a jacket, a lighting source 102 can be located substantially in the upper back portion of a garment 104, but in other embodiments, a lighting source 102 can be positioned in any known and/or convenient location on the back of a garment 104. Alternatively, a lighting source 102 can be located on a shoulder portion, sleeve, front or chest panel, collar, or any other known and/or convenient location on a garment 104. In embodiments where a garment 104 can be any other type of garment, as discussed below, a lighting source 102 can be located at any known and/or convenient location such that a lighting source 102 can be visible on the inner or outer surface of a garment 104. Although shown in FIG. 1 as located in the lower part of a garment 104, other circuit components can be located in any known and/or convenient position.

As shown in FIG. 1, a garment 104 can be a jacket, but in other embodiments can be a vest, shirt, pants, shorts, footwear, headwear, eyewear, neckwear, or any other known and/or convenient piece of clothing. In other embodiments, a garment 104 can be an accessory piece, such as a patch, harness, sash, belt, bib, or any other known and/or convenient device.

In other embodiments, the present device can not include a garment 104, but only be a retrofitting kit comprising a lighting source 102 connected in a circuit to a switch 106 and a power source 108, and an input device 110. Said kit could then be fitted into existing garments.

A switch 106 can serve to turn the circuit “on” or “off,” control a plurality of settings, or control any other known and/or convenient function of the device. In some embodiments the switch 106 can be a manual switch. However, in alternate embodiments the switch 106 can be automatic based on proximity to a predetermined item and/or based on any other known and/or desired parameter.

In some embodiments, a power source 108 can be a battery, but in other embodiments can be any other known and/or convenient portable power supply device. In some embodiments the power source 108 within the garment may be absent and the device can draw power via a direct, indirect and/or wireless coupling with an outside source.

In some embodiments, an input device 110 can be a manual selector switch with a plurality of settings that can be directly controlled by the user. Settings can include those relating to wavelength, frequency, intensity, flashing pattern, or any other known and/or convenient characteristics of the resulting lighting display from a lighting source 102. A manual selector switch can be a switch, rheostat, digital tuning mechanism and/or any other know and of convenient selection mechanism. In some embodiments, the input device can be adapted to automatically configure.

In other embodiments, an input device 110 can be a sensor that can detect various characteristics of the user or in the user's immediate environment. Such characteristics can be sound, temperature, light, motion, or any other known and/or convenient characteristic. In these embodiments, the input can be translated to an electrical or wireless signal that can control the output of a lighting source 102. The resulting output of a lighting source 102 can be varied by a signal from an input device 110 with regards to wavelength, frequency, intensity, flashing pattern, or any other known and/or convenient parameter of the resulting lighting display from a lighting source 102.

FIG. 1a depicts one embodiment of the lighting source 102. In the embodiment depicted, when a voltage is supplied across the plurality of diodes, the diodes can emit light. While depicted as an array of diodes in parallel with matched resistors and a single input voltage source, in alternate embodiments the light source can be configured in any know and/or convenient manner which will allow the individual lighting elements to be controlled between an illuminated and darkened state in any pattern and or sequence desired.

FIG. 1b depicts an alternate embodiment of the device in which the light source 102, switch 106, (optional) power source 108 and input device 110 can attached to attachment mechanisms 112, which an individual can use to wear the device. Although depicted in a harness-type configuration, the attachment mechanisms 112 can be configured in any know and/or convenient manner and can be comprised of any know and/or convenient material. In some embodiments the attachment mechanisms 112 can be adjustable and/or can be configured to be directly attached to an individual and/or garment.

FIG. 1c depicts an alternate embodiment of the device in which the light source 102, switch 106, (optional) power source 108 and input device 110 can attached to attachment mechanisms 112, which an individual can use to wear the device. Although depicted in a vertical, collar-base attachment configuration, the attachment mechanisms 112 can be configured in any know and/or convenient manner and can be comprised of any know and/or convenient material. In some embodiments the attachment mechanisms 112 can be adjustable and/or can be configured to be directly attached to an individual and/or garment.

FIG. 1d depicts an alternate embodiment of the device depicted in FIG. 1. In the embodiment depicted in FIG. 1d, the light source 102 can be configured to have any desired artistic pattern that can be illuminated in any desired manner. In the embodiment depicted in FIG. 1d, the device can include one or more illuminated segments 114 on the sleeves/arms of the garment 104. In some embodiments, the illuminated segments 114 can be configured to illuminate at the same time as the back panel light source 102 of the garment 104. However, in alternate embodiments the illuminated segments 114 can be configured to illuminate to signal at any desired time. In some embodiments the illuminated segments 114 can be configured to illuminate on the right side of the garment 104 when an individual activates a specific control, such as a right indicator on a vehicle or a motorcycle and can be configured to illuminate on the left side of the garment 104 when an individual activates a second control, such as a left indicator on a vehicle or a motorcycle. In still further alternate embodiments, desired segments of the illuminated segments 114 can illuminate upon receipt of a first signal, desired segments can illuminate upon receipt of a second signal and desired segments can illuminate upon receipt of a third signal. In alternate embodiments, any portion of the garment 104 can be configured to illuminate upon receipt of any desired transmitted signal.

FIG. 1e depicts an alternate embodiment of the device depicted in FIG. 1. In the embodiment depicted in FIG. 1e, the light source 102 can be configured to have any desired artistic pattern that can be illuminated in any desired manner. In the embodiment depicted in FIG. 1e, the device can include one or more illuminated segments 114 on the sleeves/arms of the garment 104 and chest indicators 116 on the front of the garment. In some embodiments, the illuminated segments and/or chest indicators 114 116 can be configured to illuminate at the same time as the back panel light source 102 of the garment 104. However, in alternate embodiments the illuminated segments and/or chest indicators 114 116 can be configured to illuminate to signal at any desired time. In some embodiments the illuminated segments 114 and/or chest indicators 116 can be configured to illuminate on the right side of the garment 104 when an individual activates a specific control, such as a right indicator on a vehicle or a motorcycle and can be configured to illuminate on the left side of the garment 104 when an individual activates a second control, such as a left indicator on a vehicle or a motorcycle. In still further alternate embodiments, desired segments of the illuminated segments 114 and/or chest indicators 116 can illuminate upon receipt of a first signal, desired segments can illuminate upon receipt of a second signal and desired segments can illuminate upon receipt of a third signal. In alternate embodiments, any portion of the garment 104 can be configured to illuminate upon receipt of any desired transmitted signal.

In some embodiments, as shown in FIG. 2, an input device 110 can further comprise a remote transmitter 202 and a receiver 204. A remote transmitter 202 can be activated by a manual switch, or a sensor detecting light, sound, motion, force, or any other known and/or convenient parameter.

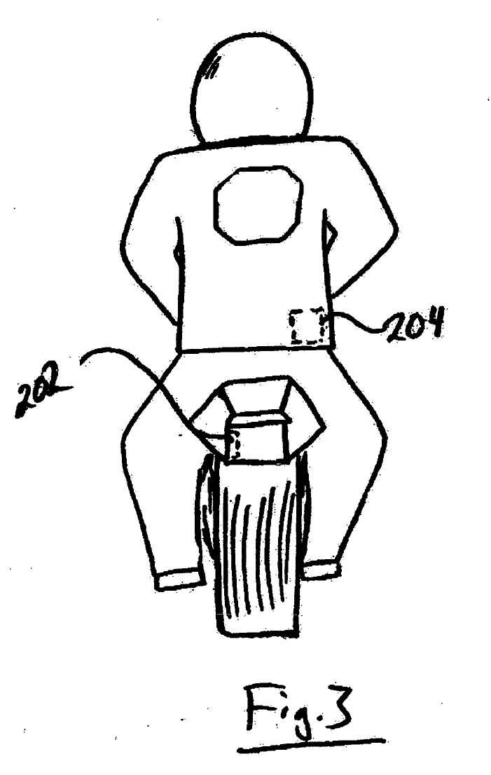

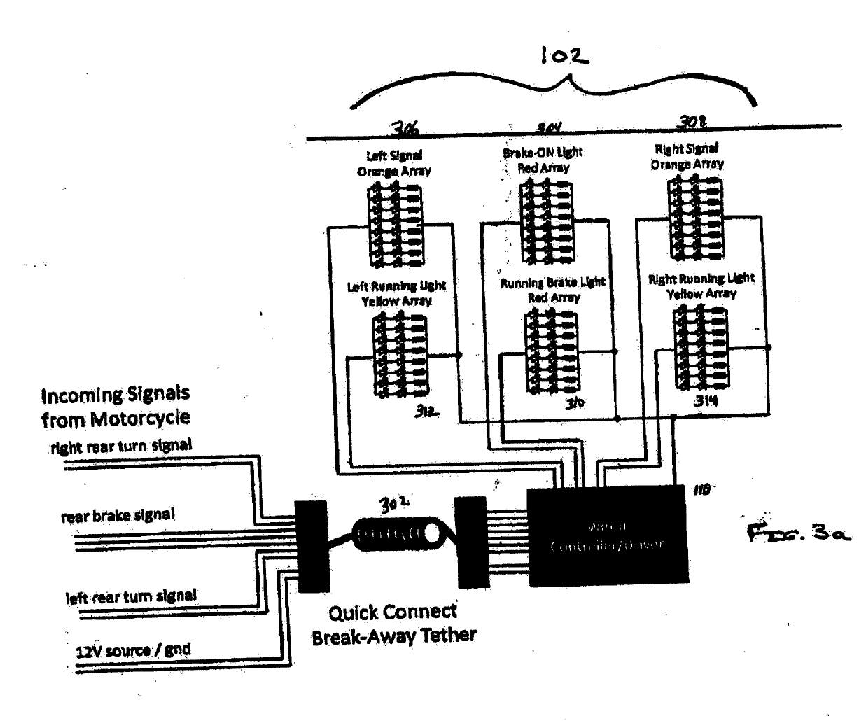

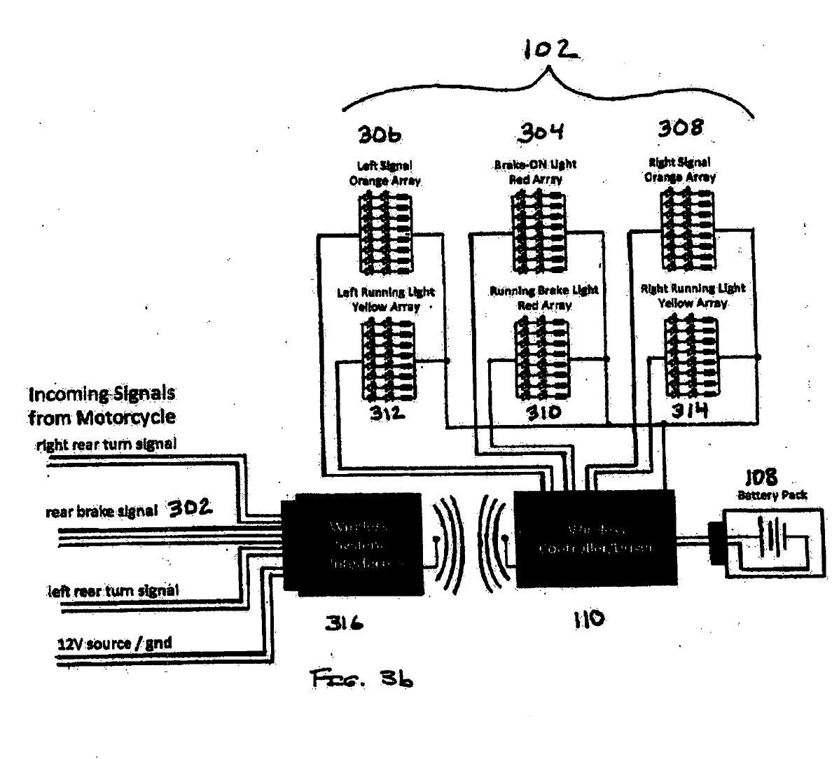

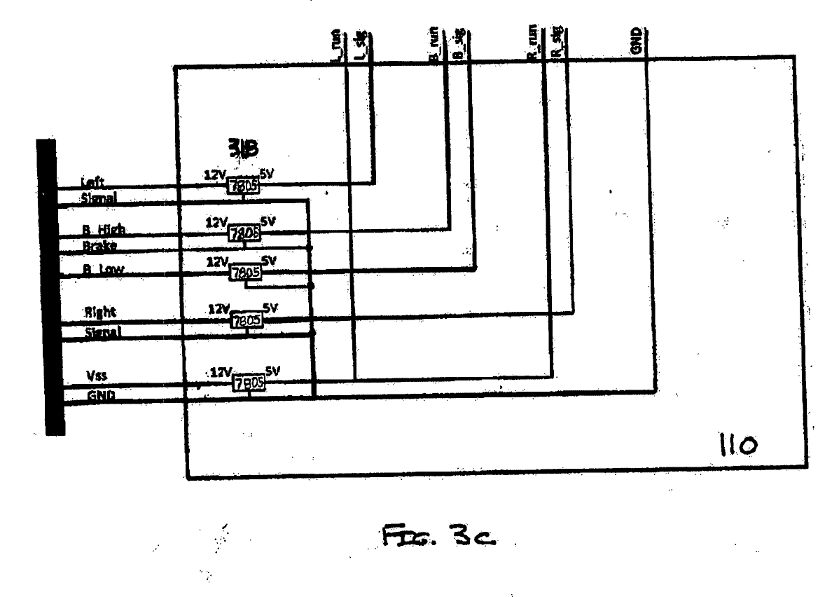

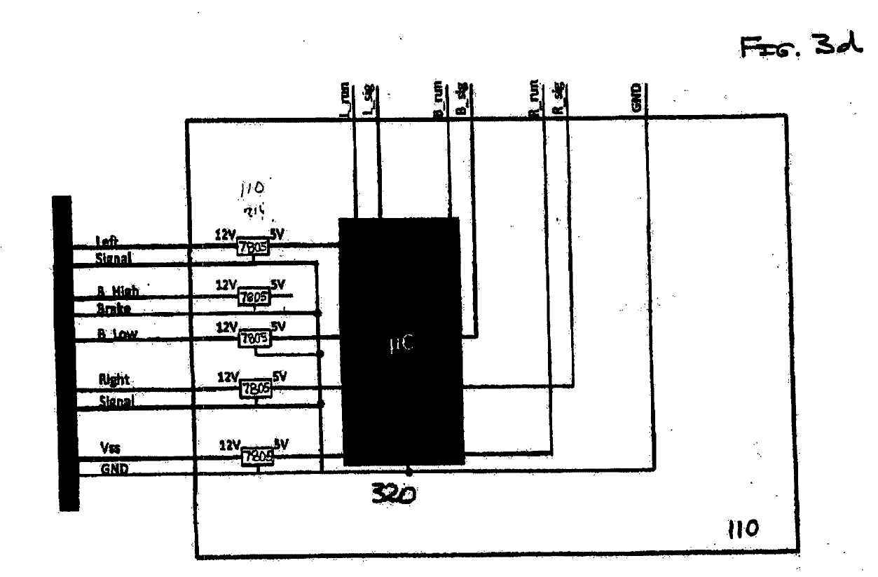

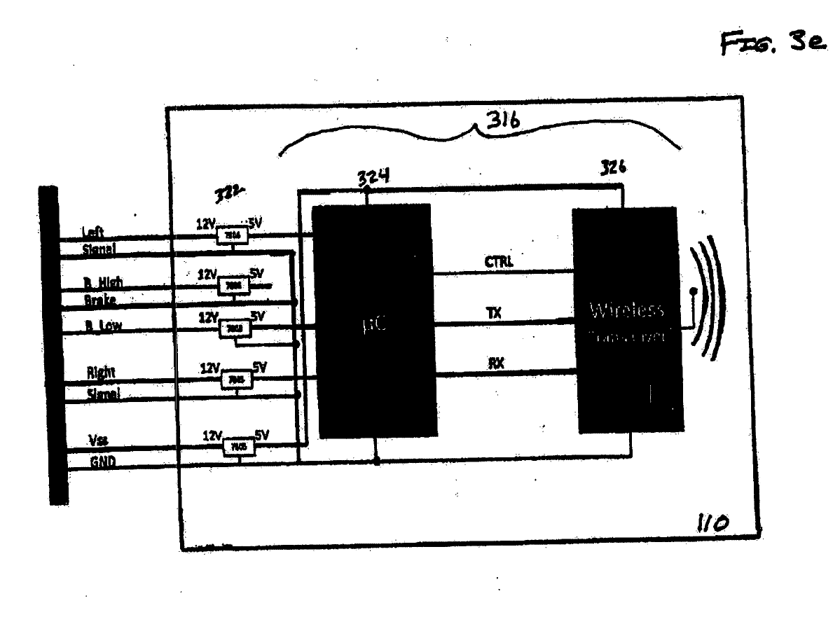

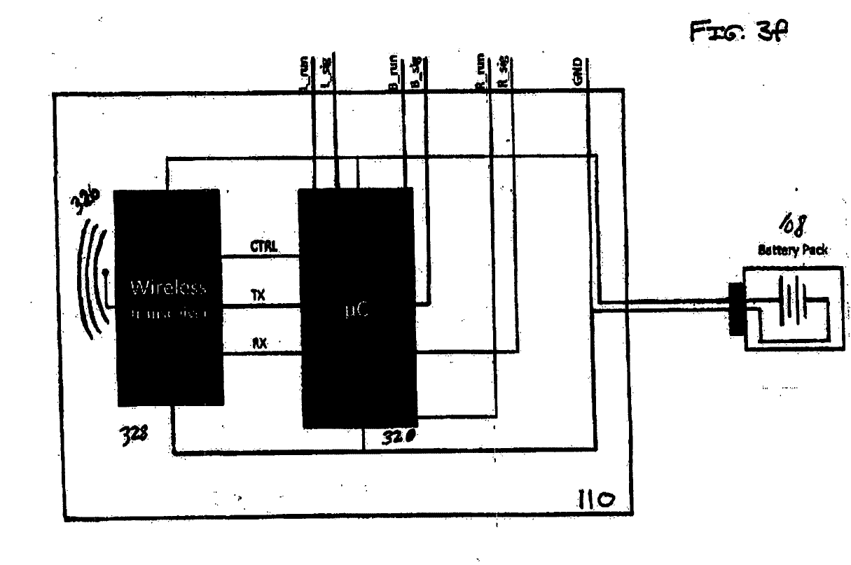

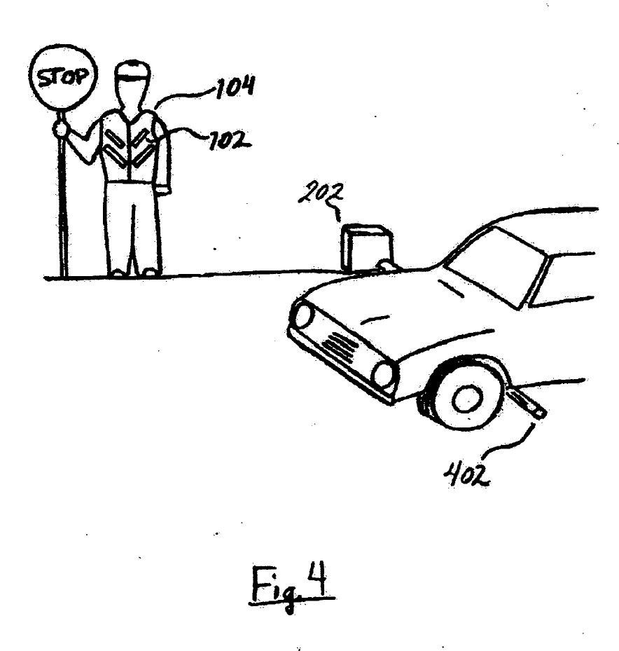

In some embodiments a remote transmitter 202 can be activated by the application of motorcycle brakes. As shown in FIG. 3, in some embodiments, a remote transmitter 202 can be equipped to detect an electrical signal resulting from the application of the brakes. Alternatively, a remote transmitter 202 can be equipped to detect a change in force or acceleration resulting from application of the brakes. In other embodiments, a remote transmitter 202 can be equipped to detect the light from an activated brake light. Any such signal can then activate a remote transmitter 202 to send a signal to a receiver 204. In some embodiments, a signal sent from a remote transmitter 202 to a receiver 204 can be wireless, but in other embodiments can be sent via an electrical, optical, or any other known and/or convenient conduit.

FIG. 3a shows a schematic diagram of an embodiment of the present device. A connector 302, which can be a quick-connect break-away tether, or any other known and/or convenient device, can receive input from the electrical system of a motorcycle. A connector 302 can receive inputs from the rear brake, left and right turn signals (front and/or rear), and a power source and ground, which can be a motorcycle battery or any other known and/or convenient device. A connector 302 can then be connected to an input device 110. In some embodiments, an input device 110 can be a wired controller/driver or any other known and/or convenient device. An input device 110 can then be connected to a lighting source 102. As shown in FIG. 3a, a lighting source 102 can comprise a plurality of lighting elements. Further, as shown in FIG. 3a, some embodiments of the present device can have a plurality of lighting sources 102 corresponding to a plurality of inputs from a motorcycle electrical system. In such embodiments, a signal from the rear brake of a motorcycle can activate a corresponding red lighting source 302, while a signal from a turn signal can likewise activate a corresponding amber, orange, or yellow lighting source 306,308 on a garment 104.

In some embodiments, as shown in FIG. 3a, each lighting source can further comprise a running light as well as a lighting source that can be activated upon signals from the electrical system of the motorcycle. In some embodiments, a running brake light red light source 310 can be paired with a “brake—ON” light red light source 304. A left running light yellow light source 312 can be paired with a “left turn signal—ON” orange light source 306. A right running yellow light source 314 can be paired with a “right turn signal—ON” orange light source 308. In other embodiments, the light sources that correspond to motorcycle turn signals can be any known and/or convenient color.

In embodiments in which the present device is directly connected to the electrical system of a motorcycle, as shown in FIG. 3a, the entire circuit of the device can be powered by a motorcycle battery. In such embodiments, a power supply 108 connected to an input device 110 can be optional or not needed.

In some embodiments, as shown in FIG. 3b, a wireless system interface 316 can be used to transmit the signals from the electrical system of a motorcycle to the input device 110. In some embodiments, an input device 110 can be a wireless controller/driver or any other known and/or convenient device. An input device 110 can then be connected to a lighting source 102 and a power source 108. As shown in FIG. 3b, a lighting source 102 can comprise a plurality of lighting elements. Further, as shown in FIG. 3b, some embodiments of the present device can have a plurality of lighting sources 102 corresponding to a plurality of inputs from a motorcycle electrical system. In such embodiments, a signal from the rear brake of a motorcycle can activate a corresponding red lighting source 302, while a signal from a turn signal can likewise activate a corresponding amber, orange, or yellow lighting source 306,308 on a garment 104.

In some embodiments, as shown in FIG. 3b, each lighting source can further comprise a running light as well as a lighting source that can be activated upon signals from the electrical system of the motorcycle. In some embodiments, a running brake light red light source 310 can be paired with a “brake—ON” light red light source 304. A left running light yellow light source 312 can be paired with a “left turn signal—ON” orange light source 306. A right running yellow light source 314 can be paired with a “right turn signal—ON” orange light source 308. In other embodiments, the light sources that correspond to motorcycle turn signals can be any known and/or convenient color.

FIG. 3c shows a sub-schematic of a wired controller/driver as an input device 110. In such embodiments, as previously discussed, the entire circuit of the device can be powered by the battery of a motorcycle, which is usually a 12-volt battery, but can be a 6-volt or other type of battery. As such, a wired controller/driver can include a voltage reducer 318 for each electrical input received from a motorcycle electrical system. In some embodiments, a voltage reducer 318 can be a solid-state voltage regulator. In other embodiments, a voltage reducer 318 can be replaced by a current regulator, relay, or any other known and/or convenient device.

In some embodiments, as shown in FIG. 3d, an input device 110 can further comprise a microcontroller 320, which can allow for programmable features. Such features can include varying flash rates and times, patterns, intensities, or any other known and/or convenient parameters.

FIG. 3e shows a sub-schematic of a wireless system interface 316 that can be used to transmit the electrical signals from the electrical system of a motorcycle to an input device 110. In such embodiments a wireless system interface 316 can be powered by the battery of a motorcycle, which is usually a 12-volt battery, but can be a 6-volt or other type of battery. As such, a wireless system interface 316 can include a voltage reducer 322 for each electrical input received from a motorcycle electrical system. In some embodiments, a voltage reducer 322 can be a solid-state voltage regulator. In other embodiments, a voltage reducer 322 can be replaced by a current regulator, relay, or any other known and/or convenient device.

As shown in FIG. 3e, a microcontroller 324 and/or any other processing device can convert signals from the motorcycle into coded wireless broadcasts of which only the intended receiver can make use. This signal encoding can ensure that riders in close proximity to one another do not experience cross-talk or interference. Encoded signals can then be sent to a wireless transceiver 326.

FIG. 3f shows a sub-schematic of an input device 110, which can further comprise a wireless transceiver 328 to receive encoded wireless signals from a wireless transceiver 326. Encoded wireless signals can be sent to a microcontroller 320, which can allow for programmable features. Such features can include varying flash rates and times, patterns, intensities, or any other known and/or convenient parameters. In wireless embodiments, an input device 110 can be connected to a power source 108.

In some embodiments, a remote transmitter 202 can be activated by the application of brakes or any other known and/or convenient device on a bicycle, scooter, or any other known and/or convenient vehicle.

In some embodiments the wireless connection and/or processor 320 can be configured to illuminate any portion and/or all of light sources 102 associated with the garment in the event that the signal received is less than a predetermined strength. Thus, in the event that a rider is separated from his/her vehicle in an undesired manner, the light sources would illuminate thus making the rider more visible to either other traffic and/or search/rescue personnel.

In some embodiments the wired connection can be configured with an alternate power source (not shown) that can be can be configured to illuminate any portion and/or all of light sources 102 associated with the garment in the event that the wired connection is severed in undesired manner. Thus, in the event that a rider is separated from his/her vehicle in an undesired manner, the light sources would illuminate thus making the rider more visible to either other traffic and/or search/rescue personnel.

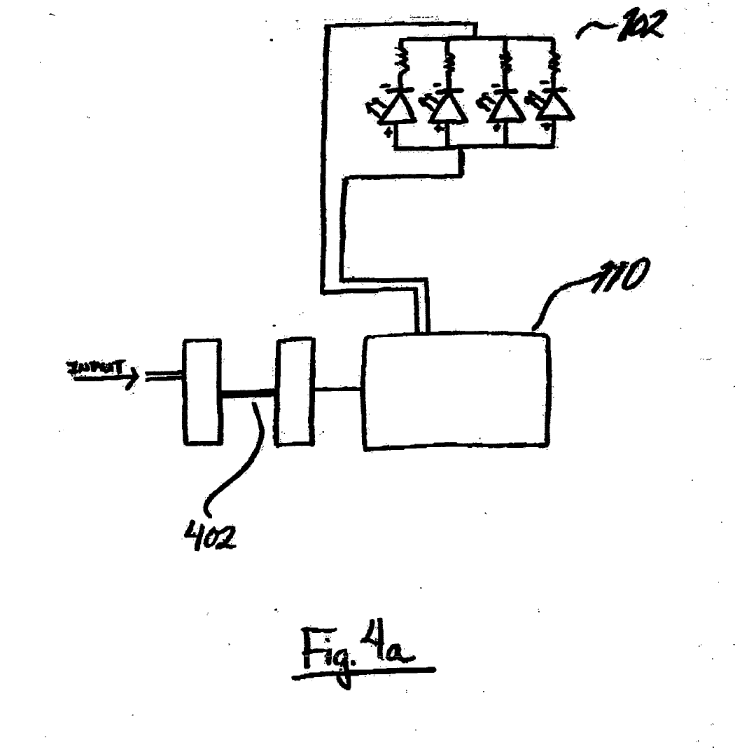

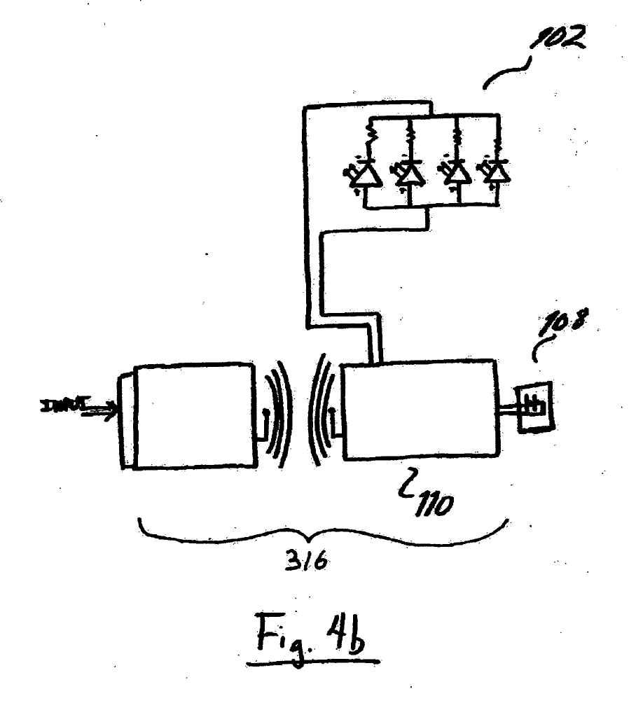

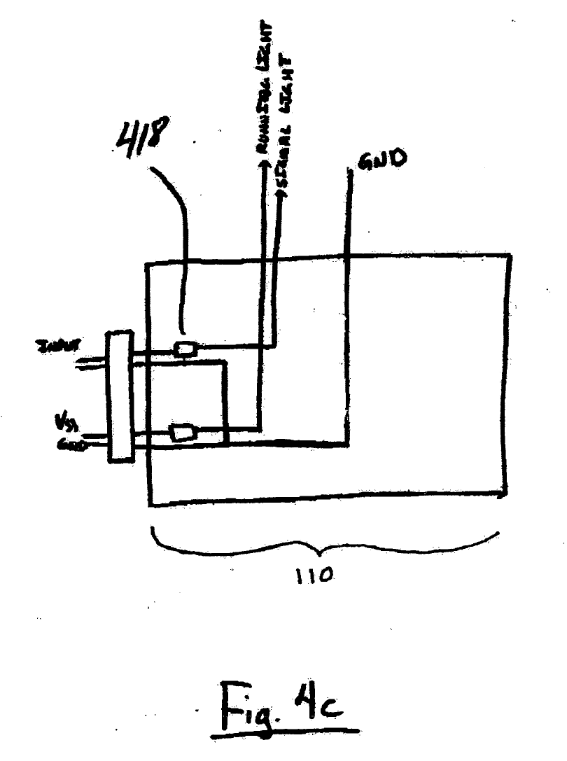

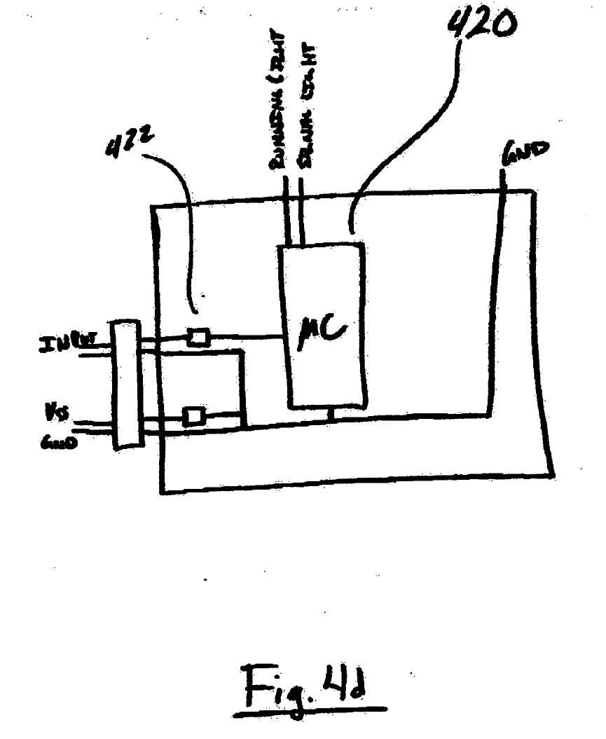

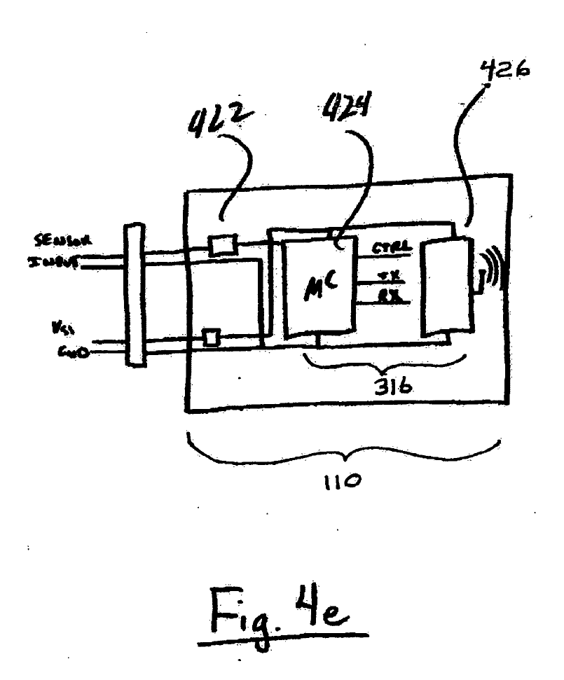

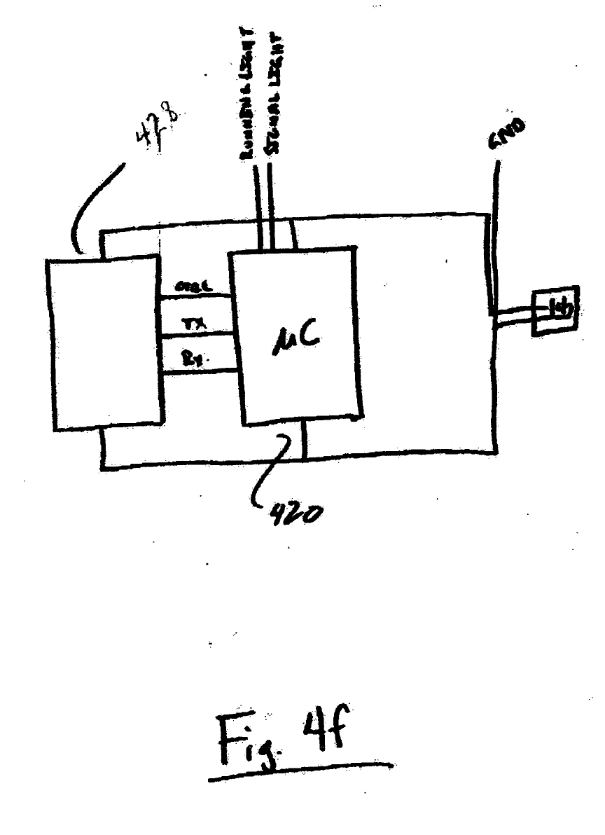

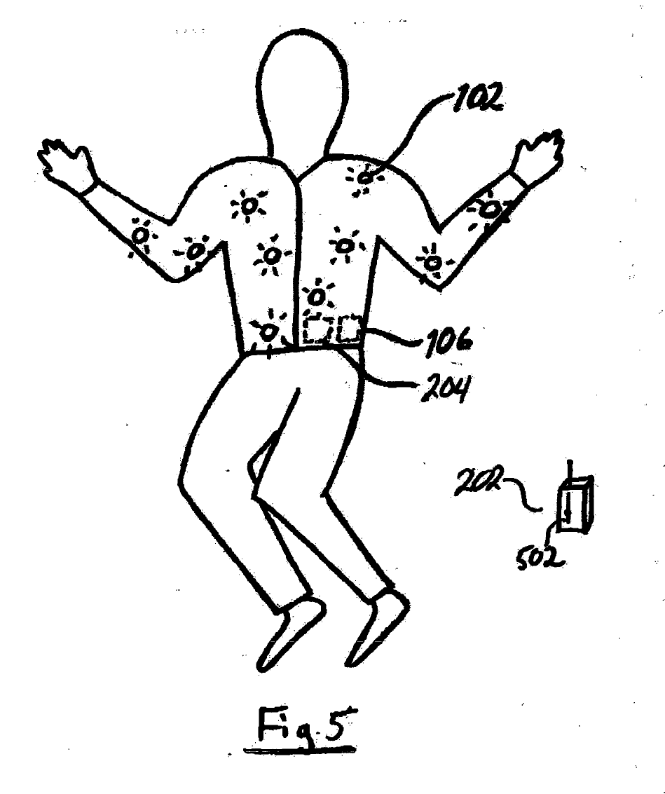

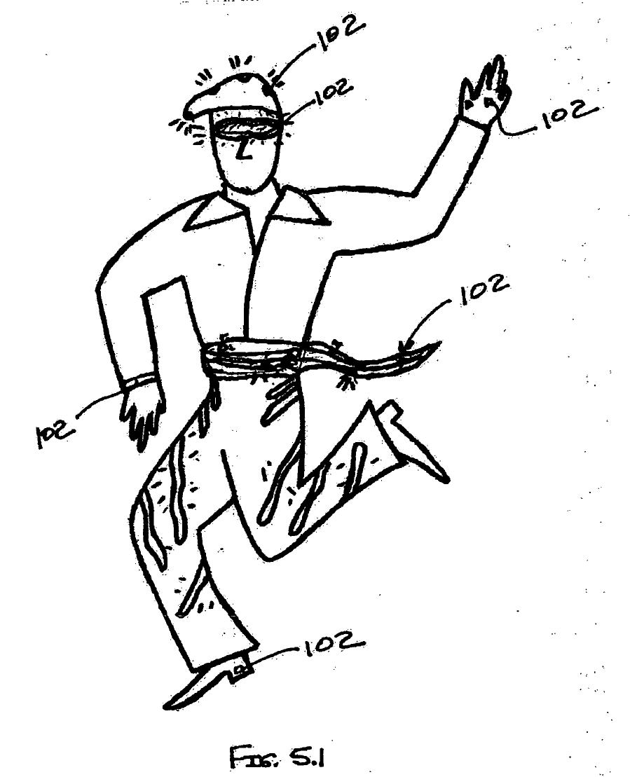

In some embodiments, a remote transmitter 202 can be activated by input from a sensor. As shown in FIG. 4, a sensor 402, which can be connected to a remote transmitter 202, can detect the force of a vehicle rolling over it. A force input can activate a remote transmitter 202 to send a signal to a receiver 204, which then sends a wireless or electrical signal to a switch 106, thereby causing a lighting source 102 to illuminate. In other embodiments, a sensor 402 can detect the motion of a vehicle moving past, or any other known and/or convenient indicator of a moving vehicle.

FIG. 4a shows a schematic diagram of an embodiment of the present device. A connector 402, which can be a quick-connect break-away tether, or any other known and/or convenient device, can receive input from the electrical system of a motorcycle. A connector 402 can receive inputs from a force, pressure, light, temperature, motion, acceleration, velocity sensor or any other known and/or convenient device. A connector 402 can then be connected to an input device 110. In some embodiments, an input device 110 can be a wired controller/driver or any other known and/or convenient device. An input device 110 can then be connected to a lighting source 102. As shown in FIG. 4a, a lighting source 102 can comprise a plurality of lighting element. In some embodiments, each lighting source can further comprise a running light as well as a lighting source that can be activated upon signals from an input device 110.

In embodiments in which the present device is directly connected to a remote sensor, as shown in FIG. 4a, the entire circuit of the device can be powered by a power source connected to a remote sensor. In such embodiments, a power supply 108 connected to an input device 110 can be optional or not needed.

In some embodiments, as shown in FIG. 4b, a wireless system interface 316 can be used to transmit the signals from a remote sensor to the input device 110. In some embodiments, an input device 110 can be a wireless controller/driver or any other known and/or convenient device. An input device 110 can then be connected to a lighting source 102 and a power source 108. As shown in FIG. 4b, a lighting source 102 can comprise a plurality of lighting elements. In some embodiments, as shown in FIG. 4b, each lighting source can further comprise a running light as well as a lighting source that can be activated upon signals from a remote sensor.

FIG. 4c shows a sub-schematic of a wired controller/driver as an input device 110. In such embodiments, as previously discussed, the entire circuit of the device can be powered by the power supply of a remote sensor. Depending upon the voltage of a power supply connected to a remote sensor, a wired controller/driver can include a voltage reducer 418 for each electrical input received from a remote sensor. In some embodiments, a voltage reducer 418 can be a solid-state voltage regulator. In other embodiments, a voltage reducer 418 can be replaced by a current regulator, relay, or any other known and/or convenient device.

In some embodiments, as shown in FIG. 4d, an input device 110 can further comprise a microcontroller 420, which can allow for programmable features. Such features can include varying flash rates and times, patterns, intensities, or any other known and/or convenient parameters.

FIG. 4e shows a sub-schematic of a wireless system interface 416 that can be used to transmit the signals from a remote sensor to an input device 110. In such embodiments a wireless system interface 316 can be powered by a power supply connected to a remote sensor. Depending on the voltage of a power supply connected to a remote sensor, a wireless system interface 416 can include a voltage reducer 422 for each electrical input received from a motorcycle electrical system. In some embodiments, a voltage reducer 422 can be a solid-state voltage regulator. In other embodiments, a voltage reducer 422 can be replaced by a current regulator, relay, or any other known and/or convenient device.

As shown in FIG. 4e, a microcontroller/processor 424 can convert signals from a motorcycle into coded wireless broadcasts of which only the intended receiver can make use. This signal encoding can ensure that riders in close proximity to one another do not experience cross-talk or interference. Encoded signals can then be sent to a wireless transceiver 426.

FIG. 4f shows a sub-schematic of an input device 110, which can further comprise a wireless transceiver 428 to receive encoded wireless signals from a wireless transceiver 426. Encoded wireless signals can be sent to a microcontroller 420, which can allow for programmable features. Such features can include varying flash rates and times, patterns, intensities, or any other known and/or convenient parameters. In wireless embodiments, an input device 110 can be connected to a power source 108.

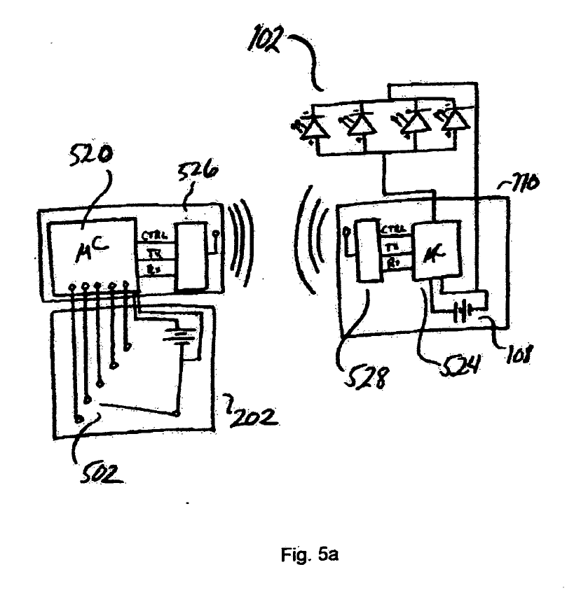

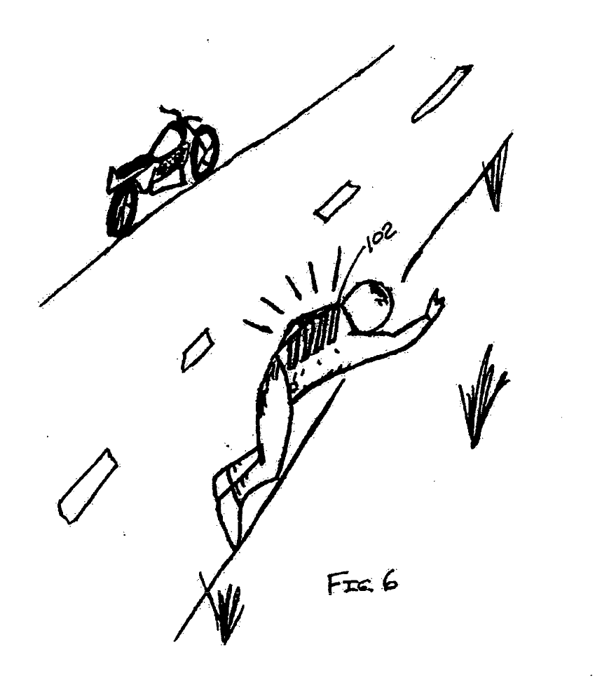

In other embodiments, as shown in FIGS. 5 and 5.1, the present device can be worn as an aesthetically enhancing garment, such as, but not limited to, a jacket, a hat, a head band, a wrist band, one or more gloves, shoes, socks, pants, glasses and/or any other known and/or convenient garment or desired item. A remote transmitter 202 can comprise a manual selector switch 502 operated by the individual and/or another person. A manual selector switch 502 can have a plurality of settings, which can include those relating to on/off, wavelength, frequency, intensity, flashing pattern, or any other known and/or convenient parameter of the resulting lighting display from a lighting source 102. In some embodiments, the illumination of all or a portion of the device can be at least partially controlled by any desired outside source, such as sound, light, pressure, external signal and/or any other desired source. In some embodiments, illumination can be controlled as desired by a signal generated by a third party. Thus, in some embodiments a Disc Jockey could either collectively, individually or in prescribed groups control the illumination of one or more of the devices.

FIG. 5a shows a schematic diagram of an embodiment of the present device having a remote transmitter with a manual selector switch 502. An input selected from a plurality of settings can be sent to a microcontroller/processor 520, which can convert signals from a switch 502 into coded wireless broadcasts of which only the intended receiver can make use. This signal encoding can ensure that persons in close proximity to one another do not experience cross-talk or interference. Encoded signals can then be sent to a wireless transceiver 526.

A wireless transceiver 528 can receive encoded wireless signals from a wireless transceiver 526. Encoded wireless signals can be sent to a microcontroller 524, which can allow for programmable features. Such features can include varying flash rates and times, patterns, intensities, or any other known and/or convenient parameters. In wireless embodiments, an input device 110 can be connected to a power source 108.

In some embodiments, the input device can activate a lighting source 102 in response to a particular event. In embodiments used for improved motorcycle safety, the input device can further comprise a coupling device, which, if separated, can trigger the activation of a portion and/or all of the lighting source 102 to illuminate with any known and/or convenient intensity, frequency, or emitting pattern. In some embodiments, the input device 602 can also activate a sound output device (not shown).

In some embodiments the wireless connection and/or processor 320 can be configured to illuminate any portion and/or all of light sources 102 associated with the garment in the event that the signal received is less than a predetermined strength. Thus, in the event that a rider is separated from his/her vehicle in an undesired manner, the light sources would illuminate thus making the rider more visible to either other traffic and/or search/rescue personnel.

In some embodiments the wired connection can be configured with an alternate power source (not shown) that can be can be configured to illuminate any portion and/or all of light sources 102 associated with the garment in the event that the wired connection is severed in undesired manner. Thus, in the event that a rider is separated from his/her vehicle in an undesired manner, the light sources would illuminate thus making the rider more visible to either other traffic and/or search/rescue personnel. A receiver 610 can then activate a lighting source 102 to illuminate with any known and/or convenient intensity, frequency, or emitting pattern.

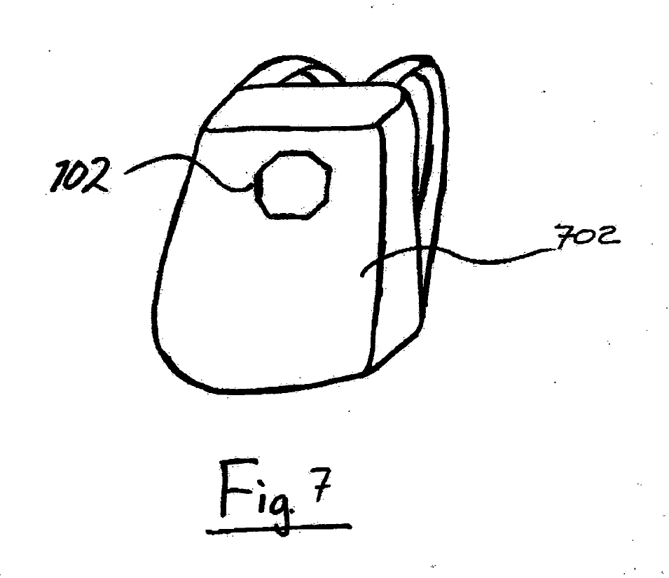

FIG. 7 depicts an alternate embodiment in which the device is embodied in a carried item, such as a backpack 702. In some embodiments, the present device can be used to enhance motorcycle safety. In such embodiments, a user can wear a garment 104 equipped with a lighting source 102, switch 106, power supply 108 and an input device 110, further comprising a receiver 204. A user can turn the circuit “on” via a switch 106. A remote transmitter 202 can be placed on a motorcycle in a location where it can detect an input parameter resulting from the application of the motorcycle brakes. In some embodiments, a remote transmitter 202 can be placed in conjunction with the electrical system of a motorcycle, such that it can detect an electrical signal resulting from the activation of the brake light when braking. When the brakes are applied, an electrical signal resulting from the activation of the brake light when braking can activate a remote transmitter 202, which can then send a wireless signal to a receiver 204. This wireless signal can then activate a lighting source 102 to turn on, increase in brightness, flash, or any other known and/or convenient output of a lighting source 102. When the brakes are no longer being applied, a remote transmitter 202 can cease sending a wireless signal to a receiver 204, which can deactivate a lighting source 102.

Some embodiments of the present device can be used for entertainment purposes, as shown in FIG. 5. In some embodiments, a user can wear a garment 104, turn a switch 106 to “on,” and in embodiments having a manual switch as an input device 110, can select from a plurality of settings to achieve a desired display from a lighting source 102. In other embodiments, an input device 110 can allow an external factor, such as sound, to activate a lighting source 102. In other embodiments, another person can have a remote transmitter 202 that can send a wireless signal to a receiver 204, which can activate a lighting source 102.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. An illuminated garment, comprising:
a. a base garment;
b. a lighting source connected to a power source, a switch, and an input device.

2. The device of claim 1, wherein said input device further comprises a receiver connected to said lighting source, and a remote transmitter.

3. The device of claim 2, wherein said remote transmitter is activated by input selected from the group consisting of: sound, temperature, light, motion, force, acceleration, and electrical.

4. The device of claim 2, wherein said remote transmitter further comprises a manual switch capable of selecting between a plurality of settings.

5. The device of claim 1, wherein said input device is a sensor capable of detecting input of the type selected from the group consisting of: sound, temperature, light, motion, force, acceleration, and electrical.

6. The device of claim 1, wherein said input device is an oscillator.

7. The device of claim 1, wherein said input device is a manual switch capable of selecting between a plurality of settings.

8. The device of claim 1, wherein said garment is selected from the group consisting of: jacket, vest, shirt, pants, shorts, footwear, headwear, eyewear, neckwear, harness, sash, belt, bib, and patch.

9. The device of claim 1, further comprising a second input device connected to said lighting source.

10. The device of claim 9, wherein said second input device further comprises a coupled device that activates said lighting source when separated.
